(19) United States
(12) Patent Application Publication
(10) Pub. No.: US 2017/0292634 A1
(43) Pub. Date: Oct. 12, 2017

(54) INTERIOR CHANNEL CABLE AND TUBE MANAGEMENT BRACKET

(71) Applicant: United Launch Alliance, L.L.C., Englewood, CO (US)

(72) Inventor: ANTHONY PAUL NGUYEN, DENVER, CO (US)

(73) Assignee: United Launch Alliance, L.L.C., Englewood, CO (US)

(21) Appl. No.: 15/479,534

(22) Filed: Apr. 5, 2017

Related U.S. Application Data
(60) Provisional application No. 62/319,730, filed on Apr. 7, 2016.

(51) Int. Cl. F16L 3/22; F16L 3/02; F16M 13/02; F16L 3/06

(52) U.S. Cl. CPC F16L 3/22; F16L 3/06; F16L 3/02; F16M 13/02

(57) ABSTRACT

A cable bracket having at least one cable support member and a subtending continuous fastener passageway with a first open end and a second open end spaced from the first open end is disclosed. The first and second open ends are oriented on the same side of the cable bracket to facilitate installation.

### CROSS-REFERENCE TO RELATED APPLICATIONS

This application claims the benefit of U.S. Provisional Patent Application Ser. No. 62/319,730, filed Apr. 7, 2016, the entirety of which is incorporated herein by reference.

### FIELD OF THE INVENTION

The present disclosure relates to support structures or brackets for securing and organizing cable, optical and/or electrical wiring, fluid lines, and other flexible or rigid tubular structures.

### BACKGROUND OF THE INVENTION

Traditional cabling and wiring harnesses, cable tie mounts or brackets, by virtue of their construction or design, give rise to inefficiencies in the installation of such cabling and wiring. Use of such traditional bracket hardware is labor intensive and, as a result, installation of cabling and wiring includes an increased labor cost. Therefore, an opportunity exists to reduce cost through improvements in cable brackets that reduce cabling and wiring installation time.

One example of a traditional support structure is a P-clamp. Installation of a cable or wire using a P-clamp requires the P-shaped band first be opened and the band fitted around a cable. Next, the band must be secured to itself to enclose the cable, typically with a fastener such as a screw. Other types of clamping style brackets similarly require the installer to manipulate the bracket to surround the cable and then secure the clamp to itself to secure the cable. Both steps are labor intensive and time consuming. Also clamp-style brackets typically have a high cost due to a high part count including bolts, spacers and washers. Clamp style brackets are also inflexible due to specific diameter sizing, requiring an inventory of differently sized clamp-style brackets for use with differently sized cabling. Examples of P-clamps include part numbers 43LC1-2 to -96, available from J&M Products, San Fernando, Calif. and part number PP1S-S10-C, available from Panduit, Tinley Park, Ill.

A second example of a traditional support structure is a comb bracket. Comb brackets are more versatile in accommodating cabling of different diameters or quantities of multiple cables. Comb brackets provide a relatively wide platform to support multiple cables and utilize multiple slots formed in the platform to receive one or more cable ties. From one side of the platform, the leading end of a cable tie is inserted through one slot. From the opposite side, the leading end is then inserted through a second different slot. Returning to the first side, the cable tie is then secured to itself surrounding one or more cables supported by the platform. Comb brackets require access to the front side and backside of the bracket or platform and multiple steps simply for positioning the tie around the cable and bracket. This is a labor intensive process. In addition, the need for access to both the front and back of the bracket reduces or limits the physical locations where comb brackets may be used. In many locations where cabling is installed, there is no access to both sides of the bracket. Further, comb brackets typically cannot be utilized with hard tubing due to the effects of vibration. The nature of a flat surface will allow a small amount of lateral movement of a tube relative to a comb bracket which will create friction. This, in turn, can result in failure of the bracket, tube or fastener. An example of a comb bracket is part number MTP1S-E10-C, available from Panduit, Tinley Park, Ill.

A third example of a traditional support structure is a U-shaped cable tie mount or bracket. A U-shaped bracket, as its name implies, has a U-shape, where a cable is positioned in the interior of the U, and the two legs of the U each include a slot to receive a cable tie. A cable tie is inserted through one slot on the outside of one leg, across the open portion of the U, and then through the slot formed in the opposing leg. If the cable is present, it must be lifted out of the way to permit the cable tie to be fed through the slots in the opposing legs. Whether the cable is present or not, it is not unusual for the leading end of the cable tie to miss the slot in the opposing leg. The slots are relatively small and the cable ties are very flexible and may have a curved shape requiring multiple attempts to effectively thread the cable tie through the two slots. Examples of these type of cable tie mounts are part numbers TM1S4-C and ABMT-A-C20 available from Panduit, Tinley Park, Ill.

A fourth example of a traditional support structure is a pedestal bracket. A pedestal bracket, as its name implies, has a pedestal that extends out from a base. A cable is supported at the top of the pedestal. A channel is formed through the pedestal with openings on opposite sides of the pedestal. For installation, the leading end of a cable tie is inserted through the opening on one side and is retrieved on the opposite side of the pedestal by the installer. The cable tie is then positioned around a cable and the cable is secured to the pedestal. Often, the surface area of the top of the pedestal is small compared to the size of the cable and provides little support for the cable. An example of this type of cable tie mount is part number ABM100-A-C, available from Panduit, Tinley Park, Ill.

### SUMMARY OF THE INVENTION

According to aspects of the present disclosure, a cable bracket is provided having a multi-sided body with a cable tie passageway having first and second open ends on the same side of a bracket body and a continuous passageway surface interconnecting the spaced openings to facilitate threading of a cable tie through the passageway in one motion. A cable support member is positioned between the passageway openings and is configured to receive cables of different sizes. The surface of the cable support member may be contoured, such as curved or concave, to provide increased surface area contact with a cable, thereby providing enhanced stability and support for the cable.

According to aspects of the present disclosure, a single bracket may have multiple cable support members for individually supporting multiple cables. Alternatively, a single cable support member may, in some circumstances, support multiple cables. The bracket may be configured such that the cable support members are horizontally spaced when the bracket is installed. Alternatively, the bracket may be configured such that cable support members are vertically spaced, or at any other orientation, such as at a slope or angle, when the bracket is installed. According to other aspects of the present disclosure, the bracket may have a generally linear configuration to attach to a flat surface, or may have a curved configuration, for example, to correspond to the exterior shape of a curved surface, such as a pipe.

According to aspects of the present disclosure, a cable bracket is provided having a multi-sided body with one or more recesses formed in one side and a cable support member extending across the one or more recesses to enclose a portion of each recess and thereby assist in defining a cable tie passageway subtending the cable support member. The cable support member may further have an outwardly curved outer surface, at least at the locations where a cable tie or fastener contacts the outer surface, such as the sides of the cable support member, when the cable tie is secured about a cable. The radius of the curvature may be optimized to reduce hoop stress or to promote the even distribution of hoop stress on the cable tie or fastener to reduce fatigue or failure of the secured cable tie over time. Other solutions, such as tie plates or comb brackets have sharp corners that can result in high tangential stress zones at fastener bend points.

According to aspects of the present disclosure, a cable bracket is provided having a multi-sided body with one or more recesses formed in and extending across the body such that the recesses are open ended. A support wall transects the recess and a cable support member extends outwardly from the support wall to define a cable tie passageway subtending the cable support member. The support wall may be centrally located relative to the recess or offset relative to the center line of the recess. The cable support member may extend in opposite directions or in one direction from the support wall.

According to aspects of the present disclosure, the cable support member may include a mounting plate with one or more cable support arms extending laterally away from the mounting plate. The one or more cable arms have a recess formed in the upper surface of the cable support arm and a cable support member extending across the recess to define a cable tie passageway beneath the cable support member. The support arm may include a curved upper side walls that provide additional support to one or more cables.

According to aspects of the present disclosure, the cable support member may include a curved or concave exterior surface for supporting cables of different diameters. In a bracket having multiple cable support members, the curvature of the cable support surface may be the same or may vary depending upon the size of the cables to be installed.

According to aspects of the present disclosure, the cross-sectional shape of the individual cable support members may vary along their length, for example, being wider at the end than in the middle. In one embodiment, the cable support member may have a tapered introductory section, a tapered exit section and a middle section having a constant cross-section. In other embodiments, the cable support member may have a constant cross-sectional shape along the length of the cable support member. In yet another embodiment, the cable support member may be wider in the middle than at the ends.

The cable brackets of the present disclosure may be made using additive or 3D manufacturing techniques which allows the brackets to be custom designed, configured and built for installation at any location.

Therefore, according to aspects of the present disclosure, the foregoing problems associated with currently available brackets for securing cables are overcome and a new cable bracket is provided having a variety of configurations that provide simplified installation of cables which, in turn, reduces installation time and corresponding cost.

As used herein, the term “cable” is intended to broadly cover not only all cables of different sizes and shapes, but also electrical and optical wiring of different sizes and shapes, and fluid carrying tubes, including for example, gas supplies, fuel and other fluids. The term “cable tie” is intended to broadly cover plastic and metal bands or straps used to secure a cable to a bracket. The term “fastener” is intended to cover all types and varieties of fastening devices, including cable ties, security or lock wire, braided string or rope, hook and loop, adhesive straps and twist ties.

The Summary of the Invention is neither intended nor should it be construed as being representative of the full extent and scope of the present disclosure. The present disclosure is set forth in various levels of detail in the Summary as well as in the attached drawings and the Detailed Description and no limitation as to the scope of the claimed subject matter is intended by either the inclusion or non-inclusion of elements, components, etc. in this Summary. Moreover, reference made herein to aspects of the present disclosure should be understood to mean certain embodiments of the present disclosure and should not necessarily be construed as limiting all embodiments to a particular description.

Further scope of applicability of the present invention will become apparent from the detailed description given hereinafter. However, it should be understood that the detailed description and the embodiments described therein, are given by way of illustration only, since various changes and modifications within the spirit and scope of the present disclosure will be apparent to those skilled in the art from the following detailed description.

### BRIEF DESCRIPTION OF THE DRAWINGS

The accompanying drawings, which are incorporated in and constitute a part of the specification, illustrate embodiments of the invention and together with the general description of the invention given above and the detailed description of the drawings given below, serve to explain the principles of the invention.

FIG. 1A is a perspective view of multiple cable brackets affixed to surrounding structure and supporting and securing a plurality of cables.

FIG. 1B is a perspective view of one of the brackets illustrated in FIG. 1A.

FIG. 1C is a cross-sectional view of the bracket and cables taken along line 1C-1C in FIG. 1B.

FIG. 1D is a top plan view of the bracket illustrated in FIGS. 1B and 1C.

FIG. 2A is a perspective view of a second embodiment of a cable bracket made according to aspects of the present disclosure.

FIG. 2B is a side elevation view of the bracket illustrated in FIG. 2A.

FIG. 2C is a cross-sectional view taken along line 2C-2C in FIG. 2A.

FIG. 3A is a perspective view of a third embodiment of a cable bracket made according to aspects of the present disclosure.

FIG. 3B is a side elevation view of the cable bracket of FIG. 3A.

FIG. 3C is a top plan view of the cable bracket of FIG. 3A.

FIG. 4A is a perspective view of a fourth embodiment of a cable bracket mad according to aspects of the present disclosure.

FIG. 4B is a side elevation view of the bracket of FIG. 4A.

FIG. 4C is a cross-sectional view taken along line 4C-4C of FIG. 4A.

FIG. 5A is a perspective view of a fifth embodiment of a cable bracket made according to aspects of the present disclosure.

FIG. 5B is a cross-sectional perspective view take along line 5B-5B of FIG. 5A.

In certain instances, details that are not necessary for an understanding of the disclosure or that render other details difficult to perceive may have been omitted from the drawings. It should also be understood that in some instances, details may have been added, such as details relating to methods of construction, including for example construction lines and dimensions, to assist in explaining the methods and structures of the preferred embodiments described herein. It should be understood, of course, that the claimed invention is not necessarily limited to the particular embodiments illustrated herein.

### DETAILED DESCRIPTION

Those of skill in the art will recognize that the following description is merely illustrative of the principles of the invention, which may be applied in various ways to provide many different alternative embodiments. This description is made for illustrating the general principles of the teachings of this invention and is not meant to limit the inventive concepts disclosed herein. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

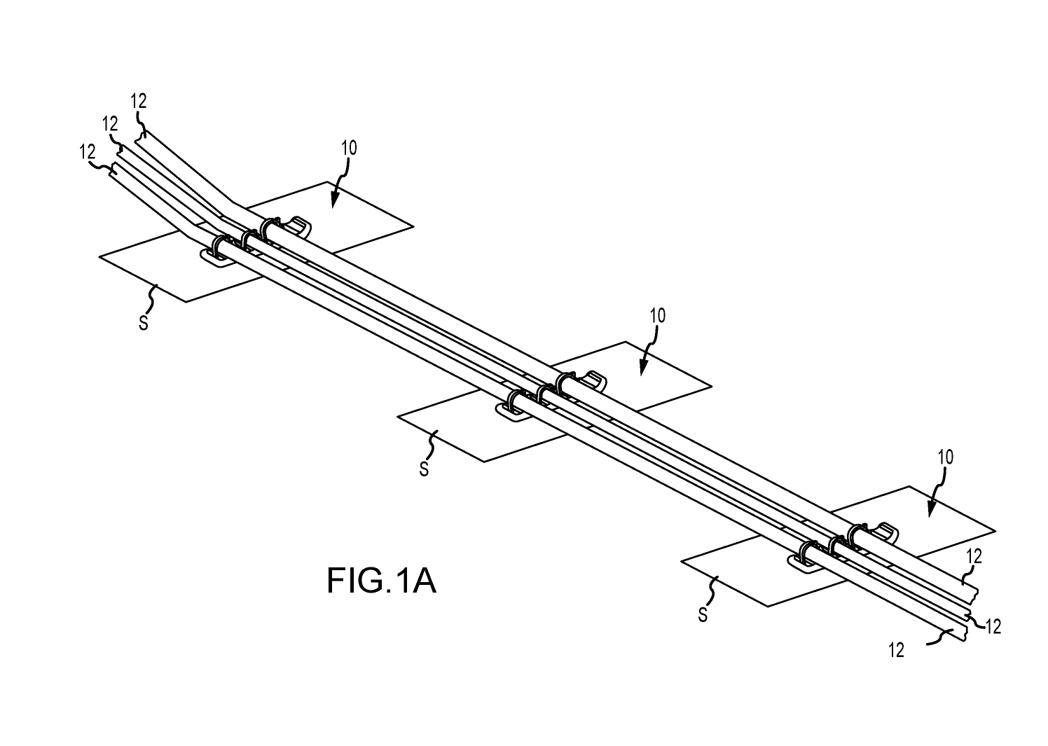

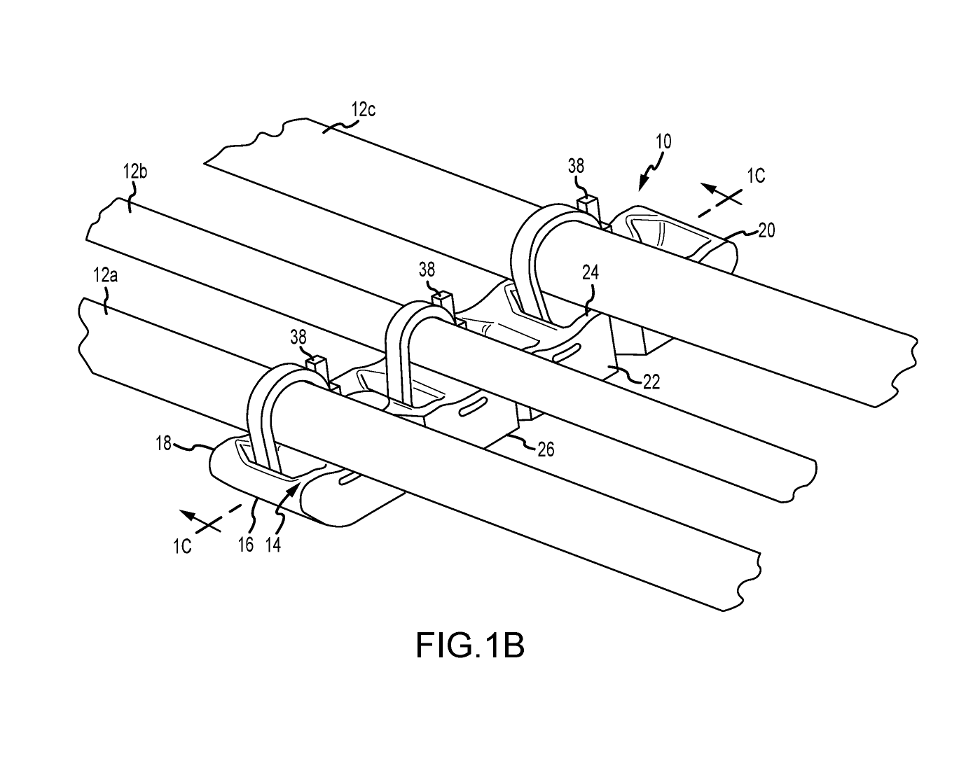

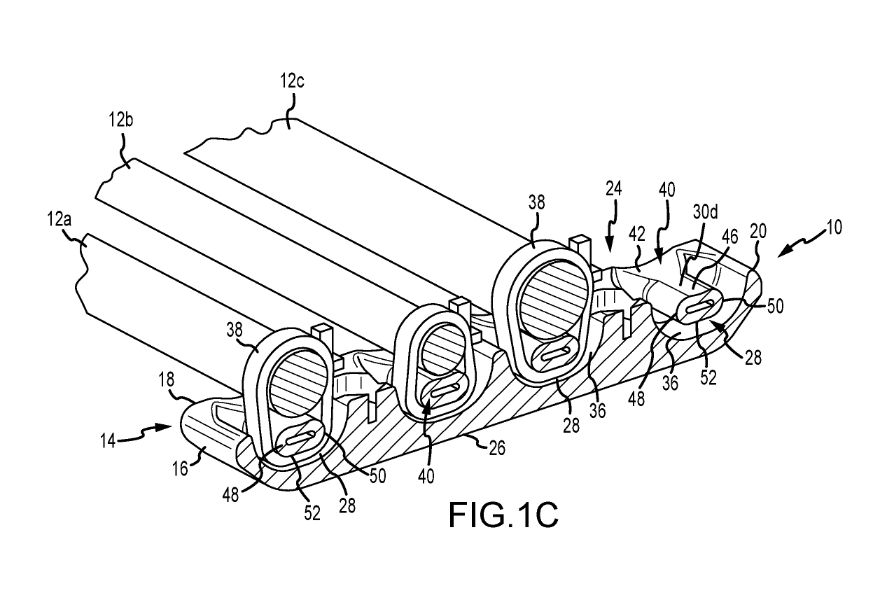

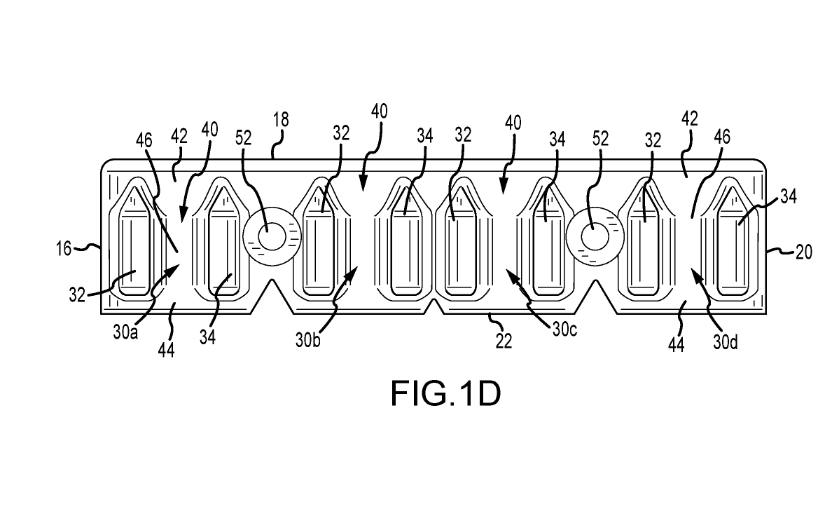

Turning to FIG. 1A, a series of brackets 10 are shown in spaced relation supporting and securing a plurality of cables 12. The brackets or harnesses 10 are secured to associated structural components S such as beams, frames or other adjacent structure. Each cable may be an electrical or optical cable, a bundle of wires, or a conduit for transporting fluids or objects, for example, pellets. As illustrated, the brackets 10 are horizontally oriented and each bracket 10 is configured to support and secure multiple cables 12. As will be appreciated from reading the present disclosure, a bracket may also be vertically oriented, or at some other angle of orientation as is needed. Additionally, a bracket 10 may be configured to support and secure a single cable or a plurality of cables 12.

FIG. 1B is an enlarged perspective view of a single bracket 10 according to aspects of the present invention. FIG. 1C is a longitudinal cross-section of that same bracket 10. FIG. 1D is a top plan view with the cables removed. As illustrated, the bracket 10 includes a body 14 with multiple sides 16, 18, 20, 22, 24 and 26, cable passageways 28 formed in the body 14, and cable support members 30a, 30b, 30c and 30d enclosing the cable passageways 28. Each passageway 28 has an open first end 32 and an open second end 34 spaced from the first end 32. In this embodiment, the first and second openings 32 and 34 of the passageways 28 are positioned on a common side 24 of the body 14. The first and second openings 32 and 34 of a passageway 28 may alternatively be positioned on different or uncommon sides. A passageway surface 36 extends continuously from the first opening 32 to the second opening 34. The passageway 28 does not have any abrupt angles or changes in direction and the continuous surface 36 forms a smooth passageway or channel from the open first end 32 to the open second end 34. Fasteners 38 are illustrated in FIGS. 1B and 1C securing cables 12 to the bracket 10. As shown the fasteners 38 are cable ties.

The first and second open ends 32 and 34 of each passageway 28 are positioned on opposite sides of the cable support member 30. Each cable support member 30 has a cable support surface 40 that is configured to receive a cable 12. In the embodiment of FIGS. 1A-1D, the cable support surface 40 is concave or curved inwardly to provide increased surface area for contact with a cable 12, which would not be the case if the cable support surface 40 were flat. The cable support members 30a-30d have a first end 42, a second end 44, and a middle portion 46 positioned between the first and second ends. The first and second ends 42 and 44 are interconnected to opposite sides 18 and 22 of the body 14. More specifically, the first end 42 is connected to side 18, and the second end 44 is connected to side 22 of the body 14. The first portion 42 of the cable support member 30 is tapered, being wider at the location where it interconnects to the body 14 than at the location where it interconnects to the middle portion 46. The second portion 44 has a less pronounced taper. The tapered first and second portions 42 and 44 provide additional cable contact surface area beyond that provided by the middle portion 46 and facilitate supporting cables having a greater diameter. FIG. 1C illustrates cables 12a, 12b and 12c with different diameters. The wider surface provides greater stability for cables of a larger diameter. As illustrated in FIGS. 1A, 1B and 1C, the bracket 10 includes four cable support members 30a-30d. It should be appreciated that a bracket 10 may be made with a single cable support member 30 and single passageway 28 or with a plurality of passageways 28 and cable support members 30.

A fastener 38 secures each cable 12 to the cable support member 30. The fastener 38 may be positioned in the passageway 28 prior to or after a cable 12 is positioned on a cable support member 30. Each passageway 28 has a continuous and smooth transitioning passageway surface 36, which facilitates simple threading of a fastener 38 around a cable 12 and cable support member 30. The leading end of a fastener 38 is inserted through the first open end 32 of a passageway 28 and, with minimal pressure or force, exits the second open end 34 of the passageway 28 in a direction away from the bracket 10 and is easily locatable by an installer. Installation is further simplified because the first and second open ends 32 and 34 of a passageway 28 are conveniently located proximate to and on opposite sides of each cable support member 30 and also because the first and second open ends 32 and 34 are located on the same side 24 of the body 14 of the bracket 10. Accordingly, an installer may feed or thread a fastener through a passageway in one motion and without need for accessing the opposite side of the bracket and without the need to manipulate the fastener 38 to align with the second open end 34.

As best seen in FIG. 1C, each cable support member 30 has curved side edges 48 and 50 and a generally flat inner surface 52 (facing the passageway 28). The radius of curvature of the side edges 48 and 50 may be configured for purposes of reducing hoop stress on a fastener 38. Over time, the hoop stress on a fastener 38 can lead to a fastener 38 breaking. Hoop stress experienced by a fastener may change over time, based upon the environment in which the bracket and cable is installed. Knowing in advance the diameter of the cable, the curvature of the sides 48 and 50 can be designed to address anticipated hoop stress on the fastener 38. Because the bracket 10 can be made using additive manufacturing techniques, such as 3D printing, the cable support members 30 can be made with different shapes.

Two apertures 52 are formed in the body 14 of the bracket 10 for purposes of securing the bracket 10 to a structural member 5 (FIG. 1A). The apertures 52 may be positioned at the interior of the body 14 as seen in FIG. 1D, or may be located at a peripheral edge of the body 14. Different methods of connecting a bracket 10 to an adjacent structure will occur to those of skill in the art upon reading the present disclosure and are deemed to be within the scope of the present disclosure. Further, the bracket 10 of this embodiment includes a flat side 26 for mounting purposes. The bracket 10 may be mounted on a horizontal surface, a vertical surface or on any other surface at any other orientation.

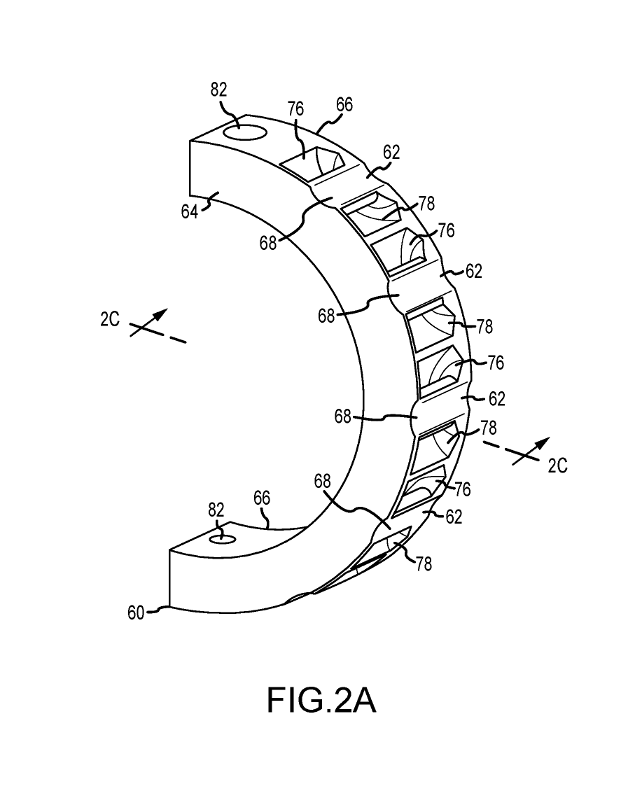

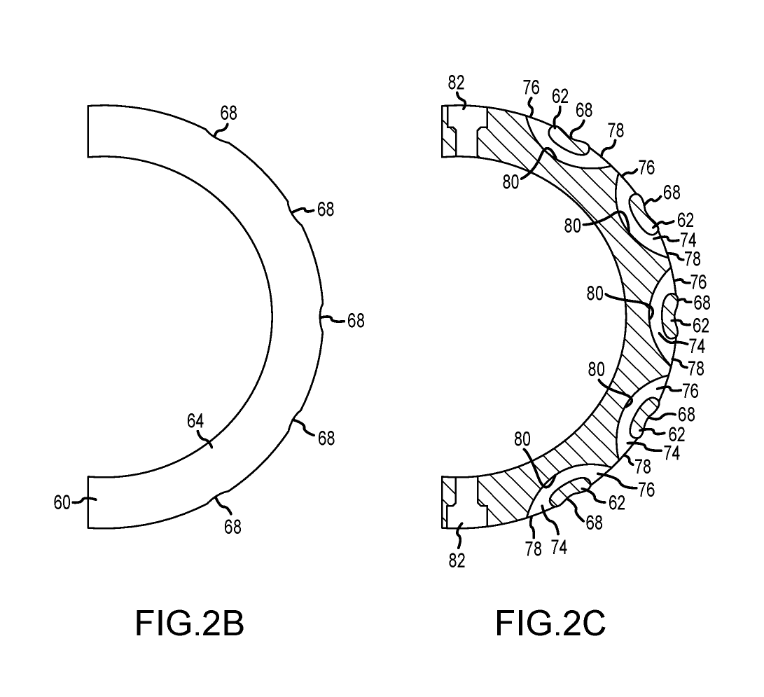

FIGS. 2A, 2B and 2C illustrate a further embodiment according to aspects of the present disclosure. Compared to the embodiment of FIGS. 1A-1D, the embodiment of 2A-2C, the body 60 is curved for mounting to a curved surface such as a pipe or tube or other similarly shaped structure. It should be appreciated that the radius of curvature may be revised to fit the curvature of any underlying support structure. As illustrated, there are five cable support members 62 which extend between a first side wall 64 and a second opposed side wall 66. Each cable support member 62 has a uniform cross-section along its length, unlike the embodiment of FIGS. 1A-1D. More particularly, the cable support members 62 do not have tapered first and second portions. However, it should be appreciated that the cable support members 62 may have the same configuration as illustrated in FIGS. 1B-1D, or a different configuration. Each cable support member 62 has a concave or curved cable support surface 68. As seen in FIGS. 2A and 2B, the curved cable support surface 68 extends through outer sides 64 and 66 of the body 62. Multiple fastener passageways 74 are formed in the body 62 of the bracket. Each passageway 74 has a first open end 76 and a second open end 78. The open ends 76 and 78 are located on a common side of the bracket, but may be positioned on different sides. The cable support members 62 enclose a portion of the passageway 74. As shown in FIG. 2C, a continuous passageway surface 80 interconnects the first open end 76 and the second open end 78. Apertures 82 are formed in the body for purposes of mounting the bracket to an underlying support structure.

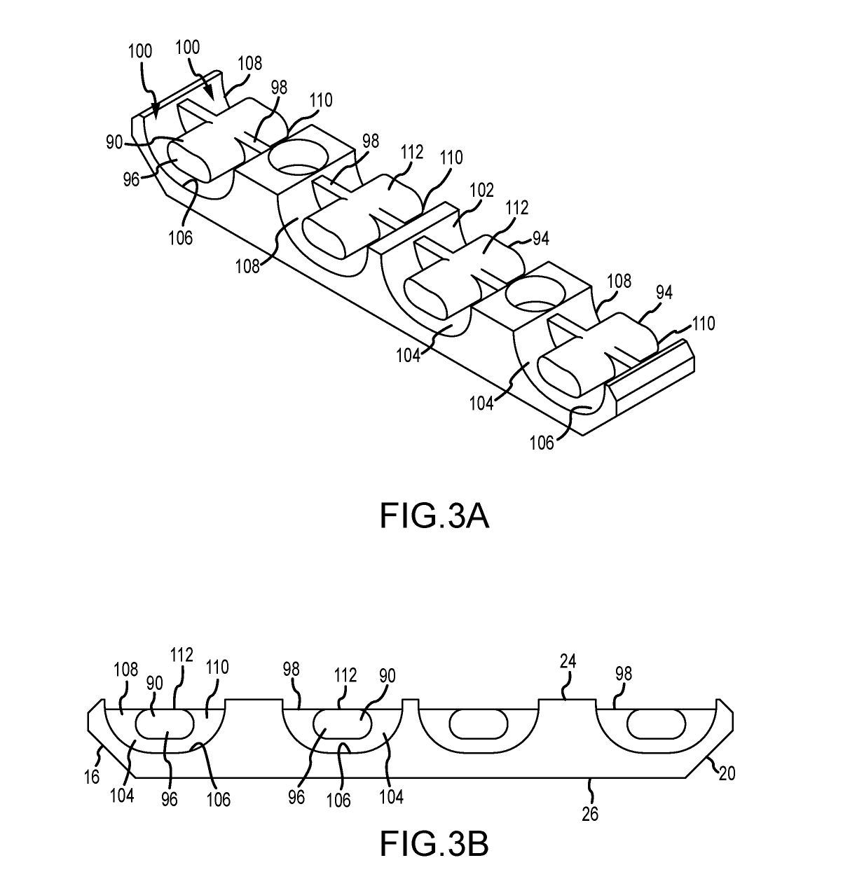

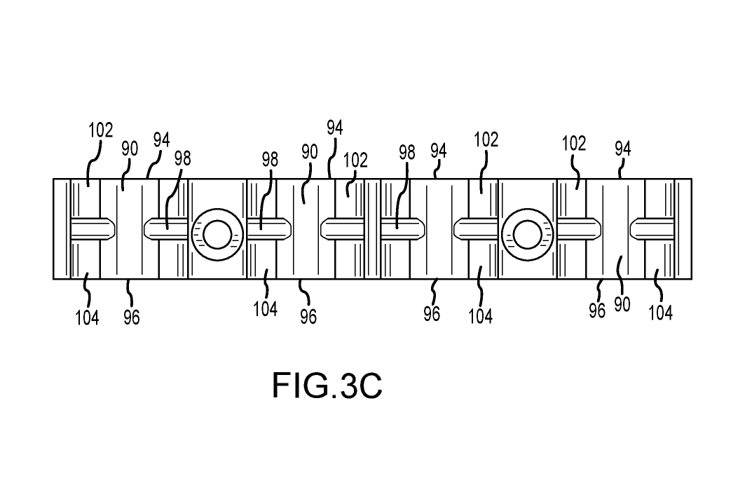

FIGS. 3A, 3B and 3C illustrate yet a further embodiment according to aspects of the present disclosure. Here, the cable support members 90 are connected to the body 92 at a point proximate the center of the cable support member 90 and are detached from the body 92 at the ends 94 and 96. The cable support member 90 is connected to the body 92 by a support wall 98. The support wall 98 bisects a recess 100 formed in the body 92 and the cable support members 90 extend away from the support wall 98. As a result, a first passageway 102 and a second passageway 104 are associated with each cable support member 90. As a result, one or two fasteners may be used with a single cable. Multiple fasteners may be relevant if the cable is subject to varying pressure loads, such as from a fluid moving through the cable. A continuous passageway surface 106 connects the first open end 108 to the second open end 110 of each passageway 102 and 104. The outer surface 112 of the cable support member is preferably concave.

It should be appreciated that the support wall 98 need not be located proximate the center of the recess 100, but may be offset at its location such that the cable support member 90 may be larger on one side of the support wall 98 than the other. For example, the support wall 98 may be positioned along one side of the body 92, forming a portion of the side of the body, and the entirety of each cable support member 90 extends away from the support wall 98. As another example, the location of the bracket relative to the surrounding structure may inhibit access to one of the passageways 102 but allow access to the second passageway 104, thereby facilitating securing of cables to the bracket. It should be appreciated that the body shown in the embodiment of FIGS. 3A, 3B and 3C, while generally linear, may be non-linear, including having a constant curve, to adapt to the shape to different underlying support structures.

Because this bracket may be made using additive manufacturing techniques, the exterior surfaces of the bracket may also be contoured to be customized to fit in locations and adapt to surrounding structures as is needed.

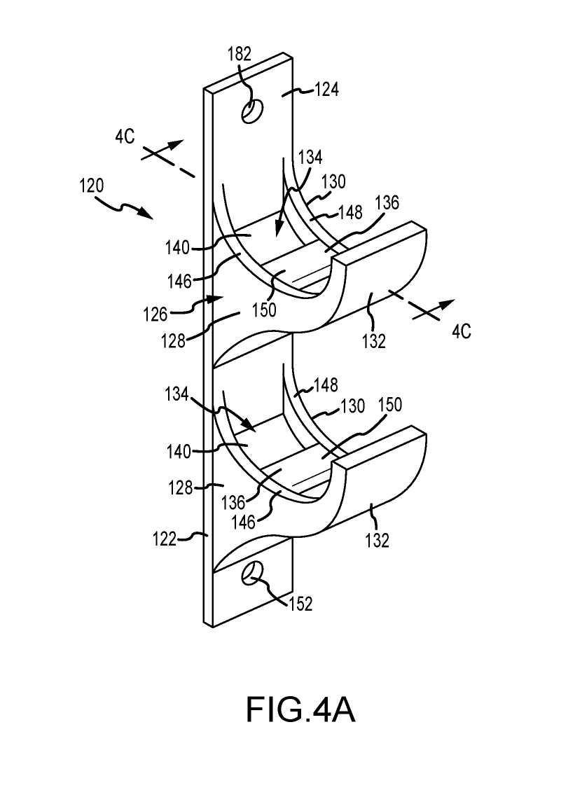

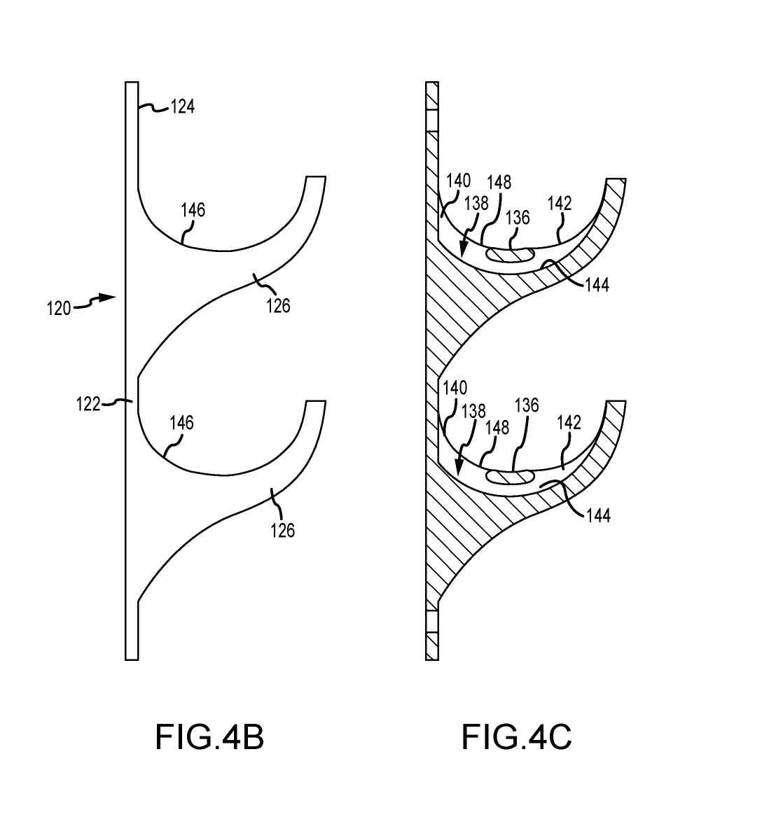

FIGS. 4A, 4B and 4C illustrate a further embodiment according to aspects of the present disclosure in which the cable bracket 120 orients the cables vertically. As illustrated, the bracket 120 includes a body 122 having a support plate 124 and one or more support arms 126 extending laterally outward from the support plate 124. In this embodiment, a support arm 126 comprises a pair of spaced side walls 128 and 130 and a bottom wall 132. A recess 134 is formed between the two side walls 128 and 130, and a cable support member 136 extends between the two side walls 128 and 130. A fastener passageway 138 subtends the support member 136. The passageway 138 comprises a first open end 140 and second open end 142 spaced from the first open end 140 with a continuous passageway surface 144 interconnecting the first and second open ends 140 and 142. The contour of the passageways is devoid of abrupt transitions to facilitate movement of a cable tie through the passageway 138. The upper surfaces 146 and 148 of the side walls 128 and 130 and the upper surface 150 of the cable support member 136 are aligned to support a cable. The first and second open ends 140 and 142 of the passageway 138 are positioned on a common side of the support arms 126. Apertures 152 for attaching the bracket 120 to a support structure are also provided. As illustrated, the bracket includes two support arms 126. It should be appreciated that brackets 120 made according to this aspect of the disclosure may have one, two or more support arms 126. As shown in FIG. 4A, the two support arms 126 are vertically aligned. It is within the scope of the present disclosure that the support arms 126 could be spaced laterally apart, such that one support arm 126 was not directly above another support arm 126. To accommodate laterally spaced support arms 126, the plate 124 may be wider or may be configured in different ways, as would be understood by those of skill in the art.

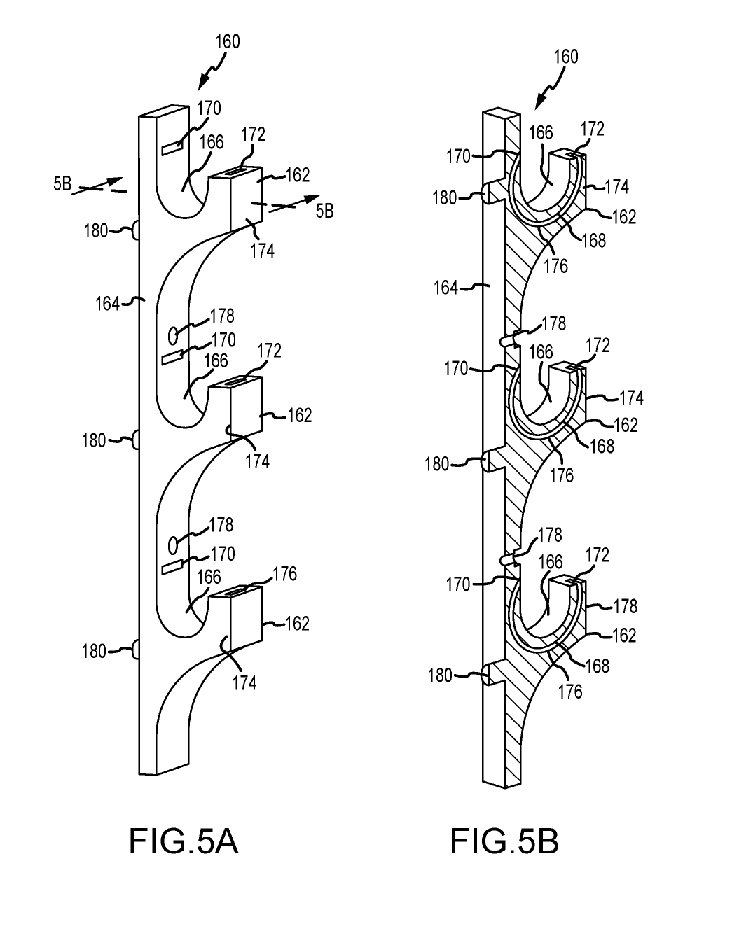

A further embodiment of a cable bracket 160 according to aspects of the present disclosure is shown in FIGS. 5A and 5B. Here, a plurality of support arms 162 extend from a support plate 164. The support arms 162 include an upper surface 166 that supports one or more cables. Passageways 168 are enclosed to a greater extent than in prior embodiments. A first open end 170 of the passageway 168 is located in the plate 164 and a second open end 172 of the passageway 168 is located at the distal end 124 of the support arm 162. However, the first and second open ends 170 and 172 remain accessible from a single side of the bracket 160, despite being located in different parts of the bracket 160. The passageways 168 extend through the entirety of the support arms 162. The passageways 168 also include a continuous and uninterrupted surface 176 connecting the first and second open ends 170 and 172. A plurality of apertures 178 are formed in the plate 164 to permit mounting of the bracket 160 to a structure. A series of outwardly extending posts 180 may also be included for purposes of aligning and securing the bracket to an associated support structure. The posts may be configured to expand upon insertion in a corresponding aperture in a support structure and may comprise the sole attachment mechanism.

The various embodiments of methods, devices, and systems used to secure cables have been described herein in detail. Such cable brackets are capable of being designed and constructed using other methods and of being practiced or of being carried out in various ways as will be readily understood by those of skill in the art upon review of the present disclosure. For example, it will be appreciated by those of skill in the art upon reviewing this disclosure that the cable support members and passageways described herein can all be sized for particular situations, to accommodate multiple fasteners within a single passageway, or to support multiple cables. Similarly, the brackets may be configured for use in virtually any orientation, to accommodate attachment to most all support structures, or to accommodate most any location where the bracket may be accessed from at least one direction. Such modifications and alterations of those embodiments as will occur to those skilled in the art upon review of the present disclosure are within the scope and spirit of the claimed invention, as set forth in the following claims. In addition, it is to be understood that the phraseology and terminology used herein is for the purpose of description and should not be regarded as limiting.

What is claimed is:

1. A cable bracket, comprising:
a. a body having multiple sides;
b. A first passageway disposed within the body, the first passageway having a first open end, a second open end spaced from the first open end and a continuous passageway surface interconnecting the first and second open ends, and wherein the first and second open ends are disposed on a common side of the body; and
c. a cable support member positioned between the first and second open ends of the channel.

2. The cable bracket of claim 1, wherein the continuous passageway surface is curved.

3. The cable bracket of claim 1, wherein the cable support member comprises a contoured surface configured to support a cable.

4. The cable bracket of claim 2, wherein the contoured surface comprises a curved surface.

5. The cable bracket of claim 1, wherein the first passageway is fully enclosed, except for the first and second open ends.

6. The cable bracket of claim 4, wherein the cable support member forms at least a part of the enclosure of the first passageway.

7. The cable bracket of claim 1, further comprising:
a. a second passageway disposed in the body and spaced from the first passageway, the second passageway having a first open end, a second open end spaced from the first open end and a continuous passageway surface interconnecting the first and second open ends, and wherein the first and second open ends of the second passageway are disposed on a common side of the body; and
b. a second cable support member positioned between the first and second open ends of the second passageway.

8. The cable bracket of claim 7, wherein the first and second openings of the first and second passageways are disposed on a common side of the body.

9. The cable bracket of claim 7, wherein the body is elongated and is curved along its length.

10. The cable bracket of claim 1, wherein the cable support member comprises a first portion and a second portion, wherein the first portion and second portion define a length of the cable support member, and wherein the first portion is tapered along its length.

11. The cable bracket of claim 1, further comprising at least one mounting bracket configured to secure the body to a separate structure.

12. The cable bracket of claim 1, wherein the cable support member has a first end portion, second end portion and a middle portion between the first and second end portions, and wherein the first and second end portions are wider than the middle portion.

13. The cable bracket of claim 12, wherein the first and second end portions and the middle portion form a continuous curved surface configured to receive a cable.

14. The cable bracket of claim 7, wherein the first and second passageways are horizontally spaced apart when the bracket is installed.

15. A cable bracket, comprising:
a. A first body portion having multiple sides;
b. A first channel formed in one side of the first body portion and defining a first side wall and a second side wall along opposite sides of the first channel, the channel having a first end, a second end and a continuous surface interconnecting the first end and second end; and
c. A cable support member extending across the first channel from the first side wall to the second side wall.

16. The cable bracket of claim 15, wherein the first and second side walls have an exterior surface, and the cable support member has an exterior surface, and wherein the exterior surface of the cable support member is continuous with at least a portion of the exterior surface of the first and second side walls.

17. The cable bracket of claim 16, wherein the exterior surface of the cable support member and the exterior surface of the first and second side walls that are continuous are concave.

18. The cable bracket of claim 17, wherein the continuous concave surfaces of the cable support member, the first wall and second side wall have the same radius of curvature.

19. The cable bracket of claim 15, further comprising,
a. a second body portion having multiple sides;
b. a second channel formed in one side of the second body portion and defining a third side wall and a fourth side wall along opposite sides of the second channel, the second channel having a first end, a second end and a continuous surface interconnecting the first end and the second end; and
c. a second cable support member extending across the second channel from the third sidewall to the fourth side wall.

20. The cable bracket of claim 15, wherein the first and second body portions are vertically spaced apart when the bracket is installed.
